(19) United States
(12) Patent Application Publication
(10) Pub. No.: US 2007/0271245 A1
(43) Pub. Date: Nov. 22, 2007

(54) System and method for searching a database

(76) Inventors: Rolf Repasi, Sunrise Beach (AU); Simon Clausen, New South Wales (AU)

Correspondence Address: BRINKS HOFER GILSON & LIONE, P.O. BOX 10395, CHICAGO, IL, 60610, US

(21) Appl. No.: 11/803,797

(22) Filed: May 16, 2007

Related U.S. Application Data
(60) Provisional application No. 60/801,895, filed on May 19, 2006.

(51) Int. Cl. G06F 17/30

(52) U.S. Cl. 707/3

(57) ABSTRACT

A method, system and computer program product for searching a database. The method comprises steps of receiving a search query from a user (200); determining context data indicative of the context of the search query (210); and using the search query and the context data to perform a search of the database (220). A method, system and computer program product for generating a database is also provided.

This application claims the benefit of priority from Provisional Application Ser. No. 60/801,895, filed on May 19, 2006, which is hereby incorporated by reference in its entirety.

### TECHNICAL FIELD

The present invention relates to a method and system of performing a search of database.

### BACKGROUND ART

Users can find it difficult to obtain relevant search results when performing a search of a database.

One particular example which illustrates the difficulty of performing a search of a database is searching the “world wide web” using an Internet search engine. When a user inputs a search query into an Internet search engine, a large number of “hits” are returned to the user. Generally search engines return a large number of “hits” which comprise at least some of the terms used in the search query. However, a large proportion of the “hits” are generally irrelevant to what the user intended. The user can systematically review each hit to determine its relevance. However, this can be a time-consuming task. Alternatively, the user can input a narrower search query into the Internet search engine. However, this can lead to some relevant information being disregarded by the search engine due to the narrower search query.

For example, if a user inputs the search query “live in Sydney” into an Internet search engine, the user is generally presented with a large number of irrelevant and relevant web pages comprising:
Web pages about moving to and/or living in Sydney;
Web pages about studying in Sydney;
Web pages with information and recording artists who performed live in Sydney;
Image galleries about living in Sydney;
Image galleries containing photos of a particular concert or event which occurred in Sydney;
Web pages with live media feeds from Sydney, such as “webcams”; and
Web pages about companies or businesses with “Live” in their name that are located in Sydney.

As can be seen from the results returned using the above search query, the user is provided with a large number of irrelevant and relevant hits. As such, the user is required to either review each hit to determine its relevance, which can be a time-consuming task, or refine the search query, which may lead to particular relevant hits being disregarded.

Therefore, there exists a need to reduce irrelevant search results when a search of a database is performed, which overcomes or at least ameliorates at least some of the disadvantages of the prior art.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### DISCLOSURE OF INVENTION

In a first aspect there is provided a method of searching a database using a processing system, wherein the method comprises steps of:

receiving, in the processing system, a search query from a user;

determining, using the processing system, context data indicative of the context of the search query; and

using the search query and the context data to perform a search of the database.

In one form the processing system is one of:

a server processing system which receives the search query from a client processing system; and

a client processing system which transfers the search query to a server processing system.

In another form the database comprises records indicative of web pages located on a network.

In one embodiment the step of determining the context data comprises steps of:

determining one or more previously submitted search queries by the user; and

using a context parser module to analyze the one or more previously submitted search queries in relation to the search query to determine the context data.

In another embodiment the method comprises:

selecting a portion of the previously submitted search queries based upon recorded user satisfaction, wherein the user satisfaction is indicative of an amount of relevance of the respective search results for the respective previously submitted search query; and

using the context parser module to analyze the portion of the previously submitted search queries in relation to the search query to determine the context data.

In an optional form the method comprises:

presenting results of the search query to the user, wherein the results comprises a number of records which at least partially satisfy the search query and/or the context data; and

determining assessment data for the presented results, wherein the assessment data is indicative of an amount of relevance of at least some of the records in relation to the search query.

In another optional form the assessment data comprises a ranking of at least some of the records.

Optionally, the method comprises at least one of:

receiving the ranking provided by input from the user; and

determining the ranking based upon an amount of time the user views each record.

In one form the step of determining the context data is based at least partially upon assessment data for the user for previously completed searches.

In another form the step of determining the context data comprises steps of:

using a content parser module to analyze one or more objects located on the processing system to determine common terms; and

using a context parser module to analyze the common terms in relation to the search query to determine the context data.

In one embodiment the step of determining the context data comprises steps of:

using a scanning module to determine application types associated with applications installed on the processing system; and

using a contest parser module to analyze the application types in relation to the search query to determine the context data.

In an optional embodiment the step of determining the context data comprises steps of:

determining a user group which the user is a member;

retrieving one or more terms associated with the group; and

using a context parser module to analyze the one or more terms associated with the group in relation to the search query to determine the context data.

Optionally, the step of determining a user group comprises receiving, from the user, an indication of the group which the user is a member thereof.

In another optional form, the method comprises:

receiving, from the user, one or more digital objects;

using a content parser module to analyze the one or more objects to determine common terms;

using a context parser module to analyze the common terms in relation to the search query to determine the context data.

In an additional or alternate form, the method comprises:

receiving, from the user, user data identifying the user;

retrieving, using the user data, data associated with previously submitted search queries for the user; and

using the data associated with previously submitted search queries and the search query to determine the context data.

In one form the identification data comprises a user name and a password.

In a second aspect there is provided a system to search a database, wherein the system comprises a processing system configured to:

receive a search query from a user;

determine context data indicative of the context of the search query; and

use the search query and the context data to perform a search of the database.

In a third aspect there is provided a computer program product for a processing system, the computer program product comprising a computer readable medium having a computer program recorded therein or thereon, the computer program product being configured to enable searching of a database using the processing system, wherein the computer program product configures the processing system to:

receive, in the processing system, a search query from a user;

determine, using the processing system, context data indicative of the context of the search query; and

use the search query and the context data to perform a search of the database.

In a fourth aspect there is provided method of generating a database using a processing system, wherein the method comprises:

determining, in the processing system, content data indicative of content of a digital object;

determining, in the processing system, context data indicative of the context of the content data with respect to the digital object; and

storing, in the processing system, the content data, the context data, and object data indicative of the digital object in a record in the database.

In one form, the digital object is a web page located on a network.

In another form, the method comprises:

launching, in the processing system, one or more web crawler modules to analyze one or more web pages located on the network, wherein each web crawler module generates the content data and the object data for the web pages; and

using, in the processing system, a context parser to parse the content data generated by the one or more web crawler modules to generate the context data.

In a fifth aspect there is provided a system to generate a database, wherein the system comprises a processing system configured to:

determine content data indicative of content of a digital object;

determine context data indicative of the context of the content data with respect to the digital object; and

store the content data, the context data, and object data indicative of the digital object in a record in the database.

In a sixth aspect there is provided a computer program product for a processing system, the computer program product comprising a computer readable medium having a computer program recorded therein or thereon, the computer program product being configured to enable generation of a database using a processing system, wherein the computer program product configures the processing system to:

determine content data indicative of content of a digital object;

determine context data indicative of the context of the content data with respect to the digital object; and

store the content data, the context data, and object data indicative of the digital object in a record in the database.

In another aspect there is provided a method of searching a database, wherein the method comprises the steps of:

providing a search query;

determining context data, wherein the context data is indicative of the context of the search query; and

using the search query and the context data to generate result data indicative of a result of a search of the database.

In another aspect there is provided a system to search a database, wherein the system comprises:

a means to provide a search query;

a means to determine context data, wherein the context data is indicative of the context of the search query; and

a means to use the search query and the context data to generate result data indicative of a result of a search of the database.

In another aspect there is provided a method of generating a database, wherein the method comprises:

determining content data indicative of content of a digital object;

determining context data indicative of the context of the content data with respect to the digital object; and

storing the content data, the context data, and object data indicative of the digital object in a record in the database.

In another aspect there is provided a system to generating a database, wherein the system comprises:

a means to determine content data indicative of content of a digital object;

a means to determine context data indicative of the context of the content data with respect to the digital object; and

a database to store a record of the content data, the context data, and object data indicative of the digital object.

In another aspect there is provided a computer readable medium of instructions to perform any of the above methods, and/or for use with any of the above systems.

### BRIEF DESCRIPTION OF FIGURES

An example embodiment of the present invention should become apparent from the following description, which is given by way of example only, of a preferred but non-limiting embodiment, described in connection with the accompanying figures.

FIG. 1 illustrates a functional block diagram of an example processing system that can be utilized to embody or give effect to a particular embodiment;

FIG. 2 illustrates a flowchart of an example of a method of searching a database;

FIG. 3 illustrates a flowchart of a more detailed example of the method of FIG. 2;

FIG. 4 illustrates flowchart of another more detailed example of the method of FIG. 2;

FIG. 5 illustrates a flowchart of an example of a method of generating a database; and

FIG. 6 illustrates a flowchart of more detailed example of the method of FIG. 5.

### MODES FOR CARRYING OUT THE INVENTION

The following modes, given by way of example only, are described in order to provide a more precise understanding of the subject matter of a preferred embodiment or embodiments.

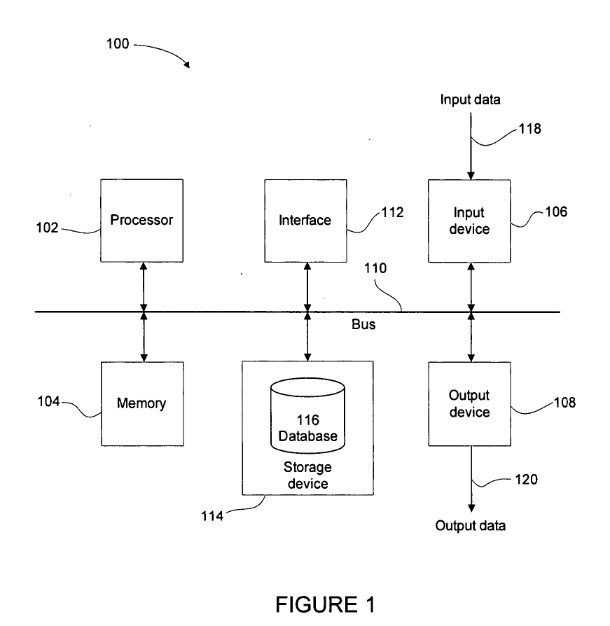

A particular embodiment of the present invention can be realized using a processing system, an example of which is shown in FIG. 1. In particular, the processing system 100 generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialized purpose. The processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

The processing system 100 may be a part of a networked communications system. Processing system 100 could connect to network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source. In one particular form, the server may transfer, to the processing system 100, data indicative of a computer program which when executed in the processing system 100 performs the method described herein.

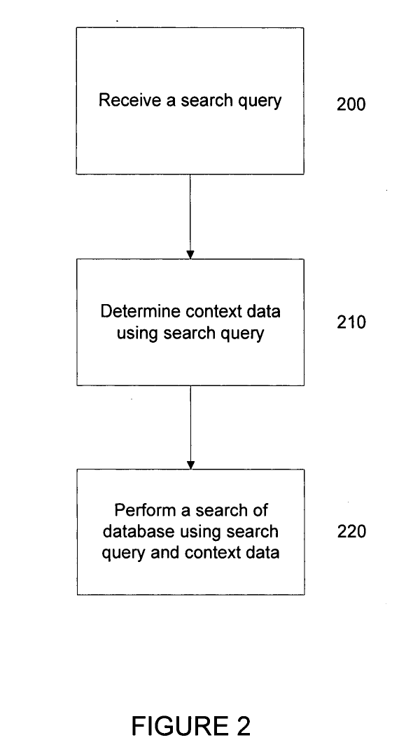

Referring now to FIG. 2, there is illustrated flow chart showing an example method of searching a database.

In particular, at step 200 the method comprises receiving a search query. At step 210 the method comprises determining context data using the search query, wherein the context data is indicative of the context of the search query. At step 220 the method comprises using the search query and the context data to perform a search of the database. In one form, the method can be implemented in the form of a search engine.

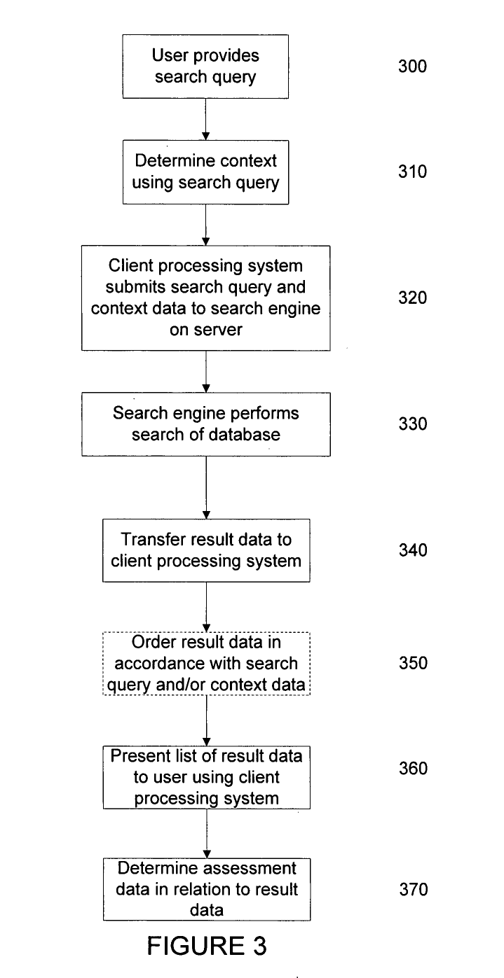

FIG. 3 illustrates a more detailed example of a method of searching a database. The example illustrates a user performing a search of the “world wide web”. However, it is noted that this example is illustrative of one particular application, and thus it should be realized that the method can be applied to a number of other different applications.

At step 300, the method comprises providing a search query. This can be performed by a user inputting a search query using a user interface for searching the “world wide web” using a client processing system. For example, the user interface may be a web page which comprises a text field allowing the user to input a search query using an input device, such as a keyboard, of a processing system. In this particular example the user has input the search query of “red”.

At step 310, the method comprises determining context data using the search query. A number of different processes can be used in order to determine the context data. Each process which can be used will be discussed in more detail below. The context data can be determined by client software running on the client processing system. It is apparent from the example search query of “red” that a number of different results could be returned by simply performing a search with this term, wherein a large proportion of the results are irrelevant. However, by determining context data associated with the search query, a more refined search can be performed.

A first process comprises determining any previous search terms which the user has previously indicated were useful in previous searches. In this regard, the user may have provided a user satisfaction indicating a rating of the search terms used in previous searches after the user has received the results from the search. In this example, the client processing system may comprise a local database which stores search terms which the user rated as useful based on the results returned from the search. However, it will be appreciated that a server processing system may store the terms and user satisfaction associated with the user in a database.

In regard to the search query of “red”, the user indicated that the term “wine” and “dog” were useful terms in previous searches and thus were stored in the local database. The client processing system can use a context parser to determine whether the term “red” is related to of the terms of “wine” and/or “dog”. The context parser can use natural language analysis, Bayesian probability/inference, and/or any other statistical analysis to determine the relatedness between terms. In this particular case, the term “red” is determined to be related to the term “wine”. Therefore, the context data in this example is indicative of the term “wine”, which qualifies that the search query “red” is in the context of red wines.

A second process comprises determining the content of objects stored locally on the client processing system. A content parser module can be used to perform a search of the documents on the client processing system to determine common terms used in the documents belonging to the user. A particular number of the most common terms found in the objects may be selected. The context parser is then used to determine whether the search query is related to any of the common terms. If one or more common terms are related, the related common terms are used to generate the context data. It is noted that the content parser may determine commonly used nouns used in the content of objects in order to determine potential context data.

For example, if the top five most commonly used terms found in the content of objects were “wine”, “dog”, “cat”, “dwarf”, and “black”, the context parser would determine that the terms “wine” and “dwarf” are related to the search query “red”. Therefore, the context data in this example would be indicative of the terms “wine” and “dwarf”.

A third process comprises scanning software installed on a user's client processing system to determine application types which can be used for determining the context of the search query. Once the application types of the installed applications is determined, the context parser determines whether the search query is relevant to any particular application type, thus indicating a context of the search query.

For example, if a large proportion of applications installed on a user's client processing system was related to spyware detection and removal, the term “red” may be in the context of “spyware”. As such, the context data generated is indicative of the term “spyware”.

A fourth process comprises the user ranking the search results received from previously performed searches. For example, the user may perform a search, wherein when the user is then presented the results of the conducted search, the user ranks a number of hits with respect to the relevance of the search query. Context data of highly ranked hits are recorded, such that when a subsequent search is performed, the context parser can determine whether a search query is related to any of the recorded context data, and if a successful determination occurs, submitting the context data with the search query to the search engine.

A fifth process comprises grouping users based on similar terms used when performing searches. In this process, the method comprises determining which group the user is a member thereof and then using common terms associated with that group to determine the context data. Additionally or alternatively, users are grouped based on their demographics. Using the grouping of the user, a context of the search query can be determined. For example, if a user is part of a wine connoisseur group, the search query red may be determined to be in the context of wine. Therefore, the context data is indicative of the term “wine”. In one embodiment, the user can indicate whether a membership to one or more groups is to be used to determine the context of the search query. In another form, the user can select the group which the context of the search is to be based upon.

It will be appreciated that a combination of these processes may be used in order to perform the search of the database. Furthermore, it will be appreciated that these processes can be performed using at least one of the client processing system and/or the server processing system.

In any event, at step 320, the processing system submits the search query and the context data to a search engine. The search engine may be located at a server processing system, and as such the client processing system transfers the search query and the context data to the server processing.

At step 330, the server processing system performs a search of the database using the search engine. The database comprises server content data indicative of the content of each web page, and server context data indicative of the context of the content of each web page. The generation of the database will be discussed in more detail below.

The search engine uses the search query and the context data to generate result data indicative of a result of the search of the database. The search engine compares the search query to the content data stored in the database and also compares the context data to the server context data. Based on this comparison, result data is generated indicative of the results of the search. The result data is generally indicative of a number of hits which are related to both the context data and the search query.

At step 340, the server processing system transfers the result data to the client processing system.

Optionally at step 350, the result data is ordered into a list in accordance with the relevance to the context data and/or search query. Thus, hits which are more relevant to the search query and the context data are ordered to appear generally at the top of the list of hits, whereas hits which were less relevant to the search query and/or context data are ordered to appear generally at the bottom of the list of hits.

At step 360, the list of result data is presented to the user using an output device of the client processing system. In this regard, the list of result data may be formatted so as to be displayed in a presentable form. If an web browser is being used as an interface, the results may be formatted to be presented in the form of a web page. As such the user can simply click a hyperlink of the web page which is indicative of the web address of the web page.

Optionally, at step 370, the result data is assessed to determine its relevance to the user's search. Assessment data can be determined by the client processing system and can be stored by the client processing system and/or transferred to the server processing system which stores the assessment data.

The assessment data may be determined by allowing the user to input a ranking of at least some of the hits presented. Additionally or alternatively, hits which are viewed by the user can be ranked higher than non-viewed hits. As is indicated below, the assessment data can be used in at least one of the processes to refine subsequent context data which is generated in future searches of the database.

Another process of assessing the relevance is monitoring the duration of time a user views a hit from the list of result data. For example, if the user views one particular web page from the list for a majority of the time, then this hit is assessed more highly than the other hits in the list of result data.

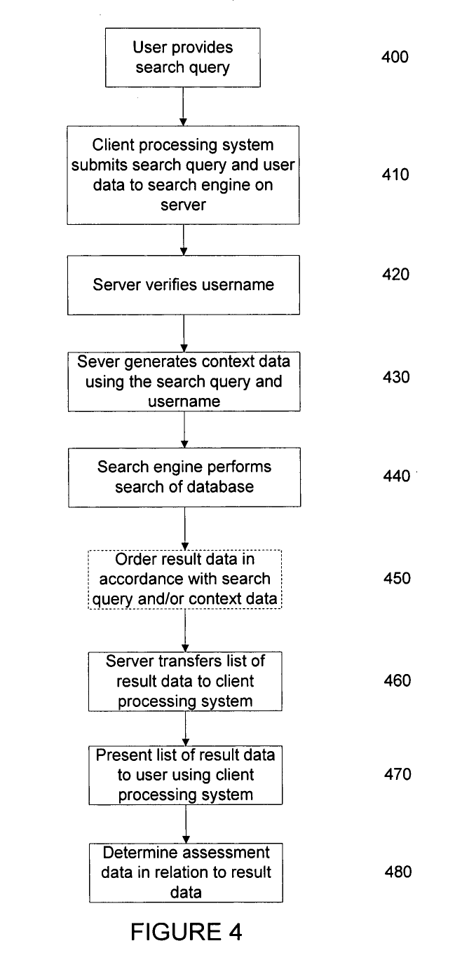

FIG. 4 illustrates a further detailed example of a method of searching a database. Again, this example is discussed in relation to performing a world wide web search using a search engine. However, it will be appreciated that the method may be used for a number of alternative applications.

At step 400, the user provides a search query which has been discussed in relation to step 300. At step 410, the search query and user data is transferred to the server processing system. The user data is indicative of the user performing the search. The user may input a unique username to the server processing system. For example, the user visits a search engine web page using a web browser and inputs a username into a text field. Optionally, the user may also provide a password to verify the user. The user data can be indicative of the username and/or password input by the user.

Optionally at step 420, the server processing system verifies the user using the username and/or the password.

At step 430, the server processing system generates context data indicative of a context of the search query submitted by the user. The server processing system comprises a user database comprising potential context data for the user. The server processing system obtains the potential context data from the user database using the user data. The server processing system then uses a context parser to determine if any of the potential context data is related to the search query provided by the user. Related potential context data is used as context data indicative of the context of the search query for the user.

At step 440, the method comprises performing a search of the database to obtain result data. This step uses the search query and the context data. This step is performed similarly to step 330.

At step 450, the method optionally comprises ordering the result data into a list according to the search query and/or the context data. This step is performed similarly to step 350. However, it is noted that the server orders the result data in this example as the server determined the context data.

At step 460, the server processing system transfers the list of result data to the client processing system to be presented to the user. Optionally, the server processing system may format the list of result data into a presentable form prior to transferring the list of result data to the client processing system. As previously indicated, the server processing system may format the list of result data into a web page to be presented to the user using an output device of the client processing system.

At step 470, the client processing system presents the list of result data, similarly to step 370.

At step 480, the result data is assessed to determine its relevance to the user's search. In this example, assessment data can be generated by the client processing system and can be transferred to the server processing system for storage in the user database. The assessment data may be determined by allowing the user to input a ranking of at least some of the hits presented. The ranking indicates the relevance of the particular hit to the search query provided by the user. The assessment data can be used in future searches to refine the context data generated for a particular search query. As such the assessment data performs a feedback function, allowing for future searches to be performed more accurately for the particular user.

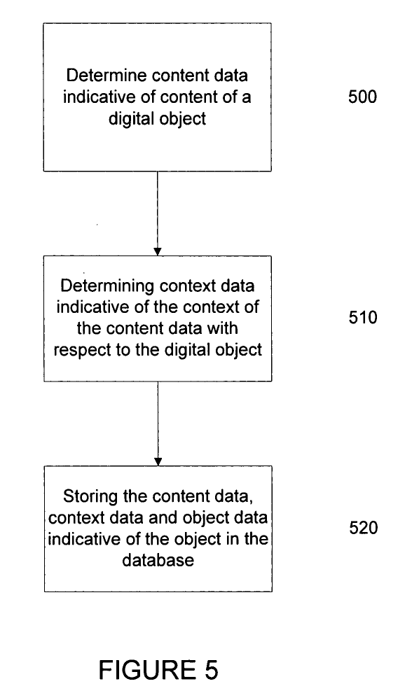

An example of a method of generating a database which can be used in a context dependent search will now be explained in relation to FIG. 5.

In particular, at step 500 the method comprises determining content data indicative of content of a digital object in a processing system. At step 510, the method comprises determining context data indicative of the context of the content data with respect to the digital object. At step 520, the method comprises storing the content data, context data and object data indicative of the object in the database.

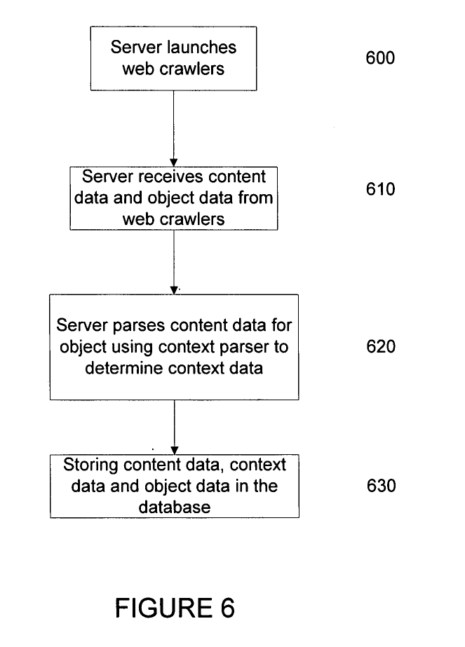

A more detailed example of a method of generating a database which can be used in a context dependent search will now be described in relation to FIG. 6. It is noted that this example is in relation to generating a database regarding web pages on the world wide web. However, it should be appreciated that the method described can be used for a number of different applications.

In particular, at step 600 the method comprises the server launching one or more web crawlers. The web crawlers crawl the world wide web analysing web pages. The web crawlers generate content data indicative of the content regarding each web page visited. The web crawlers also generate object data indicative of the digital object, which is this example is a web page.

At step 610, the method comprises the server receiving the content data and respective object data from the one or more web crawlers.

At step 620, the method comprises using a context parser to parse the content data to generate context data indicative of a context of the content for each digital object.

At step 630, the method comprises storing the content data, the context data, and the object data as a record in the database. By having such data stored in the database, a context dependent search (ie searching the database using a search query and context data) can be performed.

In one variation, the client processing system may comprise client software. The client software can allow the user to submit a search. Furthermore, the client software may determine the context data. Additionally, the client software may maintain a local database recording data such as previous search terms, common terms which appear in documents belonging to the user, assessment data as well as other data which can be used to facilitate performing a context dependent search of the database.

It is noted that the client software is optional, and that a user may simply use a web based interface to perform a search of the database. However, it is noted that any potential context data for the user which is to be stored is stored at the server processing system. The user can then use the username such as to utilize the potential context data.

In another variation, the user can input the search query and a document indicative of the context of the search query. For example, using a web interface, the user enters the term “red” in a search query text field and also attaches a file which is a digital book regarding wines. The search query and file are transferred to the server, where the server uses the context parser to parse the digital book and determine context data which is related to the search query. In this regard, the context data may be indicative of the term “wine” as well as other related terms.

In another variation, the client software may be provided in the form of a tool-bar plug-in for existing software applications. For example, the tool-bar plug-in may be for a web browser.

Optionally, search queries, context data and assessment data can be used to group users to facilitate generating more accurate context data is subsequent searches. For example, if a user submits the search query “red” and the context data is indicative of “spyware”, and the assessment data is indicative that the user considered the results data was relevant to the search, the user may be grouped into a “spyware” group such as to facilitate future searches. Group data indicative of a user group may be recorded at the client processing system such that in future searches the group data can be used for determining context data or can be submitted to the server processing system to facilitate determining the context data. Additionally or alternatively, the group data may be stored in relation to the user at the user database located at the server. Thus the server may obtain the user data when determining a context of a subsequent search query in the future.

It will be appreciated that multiple processes can be used in combination to determine the context data. Furthermore, results of particular processes may be weighted. For example, if five processes are used to determine context data and three of the processes return the same term, this common term can be more heavily weighted, and can be used to order the list of result data generated by the search of the database.

It will be appreciated that the content parser module and the context parser module can be provided in the form of hardware, software, or a combination of both.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1. A method of searching a database, wherein the method comprises steps of:
receiving a search query from a user;
determining context data indicative of the context of the search query; and
using the search query and the context data to perform a search of the database.

2. The method according to claim 1, wherein the method is performed using a processing system, wherein the processing system is one of:
a server processing system which receives the search query from a client processing system; and
a client processing system which transfers the search query to a server processing system.

3. The method according to claim 1, wherein the step of determining the context data comprises steps of:
determining one or more previously submitted search queries by the user; and
using a context parser module to analyze the one or more previously submitted search queries in relation to the search query to determine the context data.

4. The method according to claim 3, wherein the method comprises:
selecting a portion of the previously submitted search queries based upon recorded user satisfaction, wherein the user satisfaction is indicative of an amount of relevance of the respective search results for the respective previously submitted search query; and
using the context parser module to analyze the portion of the previously submitted search queries in relation to the search query to determine the context data.

5. The method according to claim 1, wherein the method comprises:
presenting results of the search query to the user, wherein the results comprises a number of records which at least partially satisfy the search query and/or the context data; and
determining assessment data for the presented results, wherein the assessment data is indicative of an amount of relevance of at least some of the records in relation to the search query.

6. The method according to claim 5, wherein the assessment data comprises a ranking of at least some of the records.

7. The method according to claim 6, wherein the method comprises at least one of:
receiving the ranking provided by input from the user; and
determining the ranking based upon an amount of time the user views each record.

8. The method according to claim 6, wherein the step of determining the context data is based at least partially upon assessment data for the user for previously completed searches.

9. The method according to claim 1, wherein the step of determining the context data comprises steps of:
using a content parser module to analyze one or more objects located on the processing system to determine common terms; and
using a context parser module to analyze the common terms in relation to the search query to determine the context data.

10. The method according to claim 1, wherein the step of determining the context data comprises steps of:
using a scanning module to determine application types associated with applications installed on the processing system; and
using a contest parser module to analyze the application types in relation to the search query to determine the context data.

11. The method according to claim 1, wherein the step of determining the context data comprises steps of:
determining a user group which the user is a member;
retrieving one or more terms associated with the group; and
using a context parser module to analyze the one or more terms associated with the group in relation to the search query to determine the context data.

12. The method according to claim 11, wherein the step of determining a user group comprises receiving, from the user, an indication of the group which user is a member thereof.

13. The method according to claim 1, wherein the method comprises:
receiving, from the user, one or more digital objects;
using a content parser module to analyze the one or more objects to determine common terms; and
using a context parser module to analyze the common terms in relation to the search query to determine the context data.

14. The method according to claim 1, wherein the method comprises:
receiving, from the user, user data identifying the user;
retrieving, using the user data, data associated with previously submitted search queries for the user; and
using the data associated with the previously submitted search queries and the search query to determine the context data.

15. The method according to claim 14, wherein the user data comprises a user name and a password.

16. A system to search a database, wherein the system comprises a processing system configured to:
receive a search query from a user;
determine context data indicative of the context of the search query; and
use the search query and the context data to perform a search of the database.

17. A computer program product for a processing system, the computer program product comprising a computer readable medium having a computer program recorded therein or thereon, the computer program product being configured to enable searching of a database using the processing system, wherein the computer program product configures the processing system to:
receive, in the processing system, a search query from a user;
determine, using the processing system, context data indicative of the context of the search query; and
use the search query and the context data to perform a search of the database.

18. A method of generating a database using a processing system, wherein the method comprises:
determining, in the processing system, content data indicative of content of a digital object;
determining, in the processing system, context data indicative of the context of the content data with respect to the digital object; and
storing, in the processing system, the content data, the context data, and object data indicative of the digital object in a record in the database.

19. The method according to claim 18, wherein the digital object is a web page located on a network.

20. The method according to claim 18, wherein the method comprises:
launching, in the processing system, one or more web crawler modules to analyze one or more web pages located on the network, wherein each web crawler module generates the content data and the object data for the web pages; and
using, in the processing system, a context parser to parse the content data generated by the one or more web crawler modules to generate the context data.
